(19) United States
(12) Patent Application Publication
(10) Pub. No.: US 2002/0130753 A1
(43) Pub. Date: Sep. 19, 2002

(54) Magnetic components produced using multilayer ceramic chip technology

(75) Inventors: Walter Merriam, Vista, CA (US); John Harrison, San Marcos, CA (US); Joseph Crownover, San Diego, CA (US)

Correspondence Address: DONN K. HARMS, 12792 Via Cortina, Suite 100, Del Mar, CA, 92014, US

(73) Assignee: CHIPTRONICS, INC.

(21) Appl. No.: 09/811,105

(22) Filed: Mar. 16, 2001

(51) Int. Cl. H01F 27/28

(52) U.S. Cl. 336/223

(57) ABSTRACT

The present invention is related to magnetic components produced using MLCC technology. According to one or more embodiments of the present invention, a magnetic component is constructed by a process of building up multiple layers of non-conductive material and combining the layers to form one unit. On certain layers a conductive material is used to create a pattern that equates to a full loop or winding. The pattern when printed on multiple successive layers and caused to come into electrical contact with one another replaces the coil used in conventional magnetic components. The layering process may be repeated until the desired number of turns is achieved where each layer may be configured to represent a full turn or a smaller degreed turn.

### BACKGROUND OF THE INVENTION

1. Field of the Invention

The present invention relates to the manufacture of magnetic components, and in particular to using multilayer ceramic chip (MLCC) technology to produce such components.

2. Background Art

Magnetic components use a conductive coil. A conductive coil comprises one or more turns of current-carrying wire designed to produce a magnetic field when energized by an AC voltage. Examples of magnetic components that use such a coil include, but are not limited to, transformers, inductors, relays, solenoids, and motors. As devices have become more and more miniaturized there is a need to use smaller and smaller magnetic components. Magnetic components comprised of wire-wound coils, however, are inadequate because current techniques to miniaturize such components are inhibited by the ability to produce a coil that is sufficiently small and economically feasible.

Before further discussing the drawbacks associated with current magnetic components, it is instructive to discuss a particular type of magnetic component conventionally known as a transformer by way of example.

Transformers

A transformer is a device that transfers electric energy from one alternating-current (input) circuit to one or more other (output) circuits, either increasing (stepping up) or reducing (stepping down) the voltage. Transformers are employed for widely varying purposes. Some are used to reduce the voltage of conventional power circuits to operate low-voltage devices, such as doorbells and toy electric trains and low voltage electronic devices. Other types of transformers are used to raise the voltage from electric generators so that electric power can be transmitted over long distances.

In operation, a transformer uses an alternating current (AC) voltage communicated to an input coil to induce a magnetic field. This magnetic field therein induces a voltage in the output coils of the transformer. Transformer operation depends on a changing magnetic field. Conventional transformers use a core section, featuring a plurality of coils or windings, to confine and concentrate the magnetic field. The input coil is called the primary coil, and the output coil is called the secondary coil. These coils are electrically insulated from each other.

Transformers are generally used for their ability to change the voltage and/or their ability to isolate the input and output voltages. The secondary voltage is calculated by multiplying the primary voltage by the ratio of the number of turns in the secondary coil to the number of turns in the primary coil, a quantity called the turns ratio. V^{S}=V^{P} (TS/TP), or E2=E1 (N2/N1) where: V^{S}=E²=Secondary Voltage, V^{P}=E1=Primary Voltage, T^{S}=N²=Secondary Turns, T^{P}=N¹=Primary Turns.

FIG. 1 shows an example of a typical conventionally constructed transformer. Primary coil 100 of FIG. 1 has N1 turns, while secondary coil 110 has N2 turns. Coils 100 and 110 are separated from one another by electrically insulated area 120 and are wound around the core of magnetic material 130. In operation an input voltage E1 is transformed to an output voltage E2 where E1 and E2 may be different voltages.

Current Magnetic Components

Current magnetic components, such as the transformer described in FIG. 1, are required for many applications where the overall size of the device into which they are integrated, is ever decreasing. In attempting to meet the goals of miniaturization, manufacturers continue to attempt to produce wires wound on a smaller and smaller scale. This approach, however, is ineffective for several reasons.

First, the coils required of such magnetic components are produced one at a time in a time-consuming fashion. Consequently producing a huge amount, of very small coils, results in a very expensive and time-consuming venture. Second, the very nature of using a wire-wound coil in a magnetic component introduces physical limitations which limit how small they can be produced. Third, clearances must be allowed to assemble the various parts of such magnetic components, resulting in an overall inefficient use of space. Finally, original equipment manufacturers, using existing technology in production of their products, incur greatly increased production costs because of the need to place the magnetic component on a circuit board by hand, or through the use of special handling equipment. This increases costs inversely to the decrease in the size of the component.

### SUMMARY OF THE INVENTION

The present invention is related to magnetic components produced using MLCC technology. According to one or more embodiments of the present invention, a magnetic component is constructed by a process of building up multiple layers of non-conductive material, such as ceramic or ferroceramic, and heating the layers so that they combine to form one unit.

On certain layers of the non-conductive material, a conductive material, such as palladium, is deposited to create a pattern. The pattern, when printed or otherwise deposited upon multiple successive layers, and caused to come into electrical communication with one another through vias, creates a series of turns which replicate the conventional coils or windings used in conventional magnetic components.

In one embodiment of the device herein disclosed, the pattern is substantially a square, except having a starting point and an ending point that are slightly offset. On multiple successive layers, this square-like pattern is flipped about its center line. Then, regions on the nonconductive layers are produced so that each successive layer comes into operative electrical contact with the next successive layer at their respective starting and ending points. Communication or electrical connections between the layers are provided through holes, called vias, which are punched in the non-conductive layers such that the vias register to the proper position to allow one layer comes into electrical communication with the start of the next successive layer.

This layering process may be repeated until the desired number of turns is achieved where each layer may be configured to represent a full 360 degree turn or a smaller degreed turn and thereby replicates the number of turns in the conventional wire-wound coil.

In another disclosed embodiment, the turns of the coil are produced by stacking the layers having the conductive ink deposited in the proper pattern thereon and connecting them electrically. Next, one or more layers of non-conductive material are stacked upon the aforementioned coil. Then, the layering process repeats where another coil is produced using layers of ceramic having the conductive pattern connected electrically. The component thereby produced corresponds to a conventional magnetic component, such as a transformer, having a primary and secondary coil.

Finally, the entire configuration of stacked layers combined which in the current best mode uses heat in a firing process such as a kiln, or similar heating process, to form a solid or unitary object that corresponds to the desired magnetic component but is much more compact, and may be much smaller than conventional devices which can be produced using wound coils and preformed cores.

### BRIEF DESCRIPTION OF THE DRAWINGS

These and other features, aspects and advantages of the present invention will become better understood with regard to the following description, appended claims and accompanying drawings where:

FIG. 1 is a diagram of a conventional magnetic component called a transformer.

FIG. 2 depicts a stack of layers having a conductive pattern deposited thereon and the registered vias operatively positioned to allow desired electrical connections between layers.

FIG. 3 is an exploded side view showing stacked layers with conductive patterns and communication therebetween as well as top and bottom cover layers separated by a separation layer.

FIG. 4 depicts an end view of and assembled layered coil showing the contact points at each end communicating externally.

FIG. 5 is a section view through an embodiment of stacked layers showing the disclosed device configured as a solenoid.

FIG. 6 depicts a side view of the disclosed device in the form of a transformer with two stacked sections defining coils and showing communication points to each end of the receptive coils for attachment to a circuit.

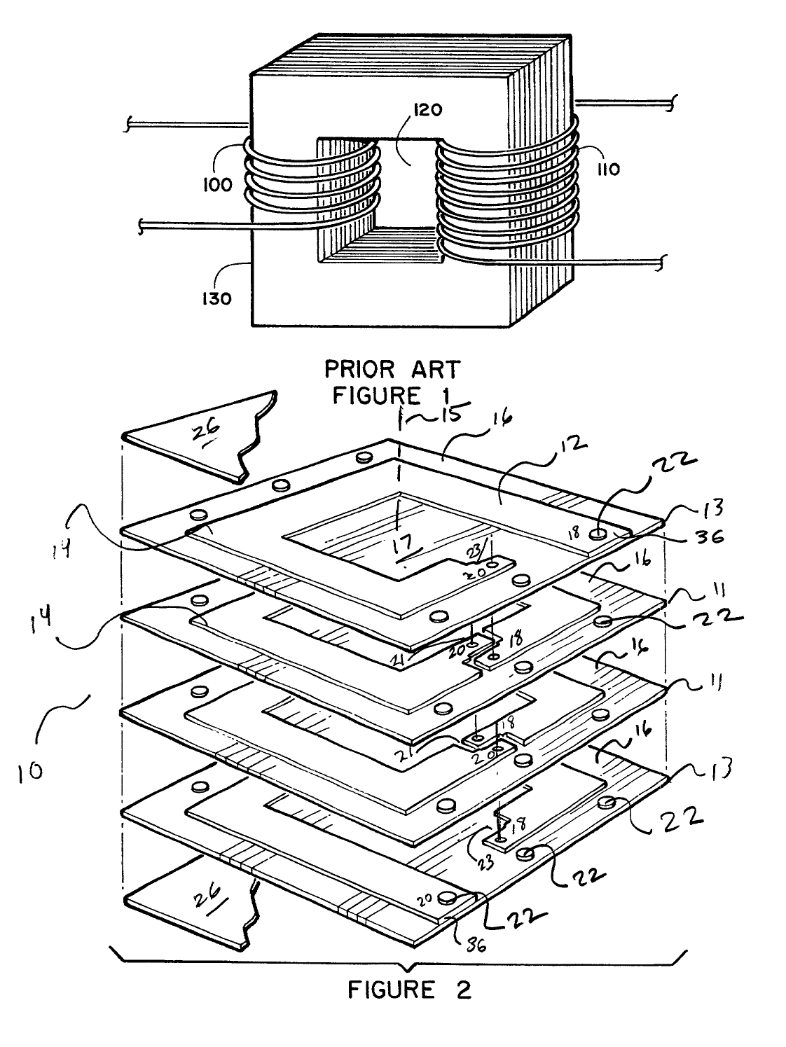

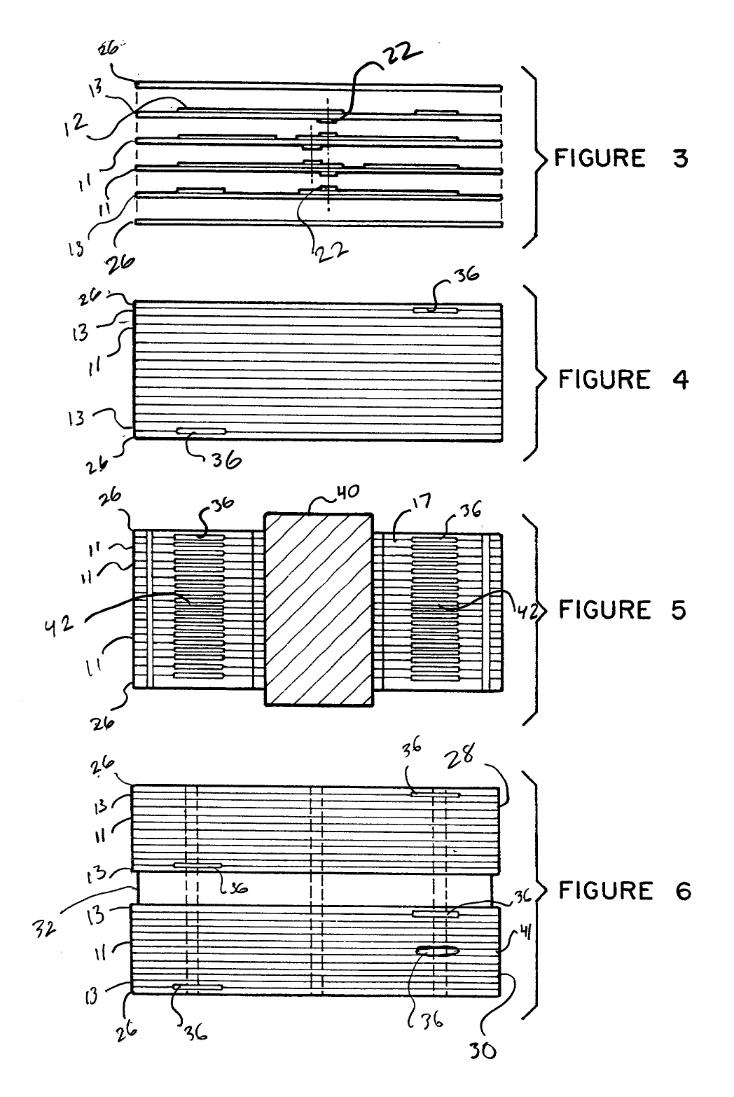

### DETAILED DESCRIPTION OF THE INVENTION

Embodiments of the present invention are directed to producing magnetic components formed using MLCC technology. In the following description, numerous specific details are set forth to provide a more thorough description of embodiments of the invention. It will be apparent, however, to one skilled in the art, that the invention may be practiced without these specific details. In other instances, well-known features have not been described in detail so as not to obscure the invention.

MLCC Technology

MLCC technology is a process of building up multiple layers of non-conductive material, such as ceramic or ferroceramic, and thereafter heating the stacked layers so that they combine to form one electronic component unit of unitary construction. MLCC technology may be fully automated, in that there is no need for a person to individually handle the small components. Hence, it can be used to produce a very small finished product at decreased cost and increased efficiency. Since the products produced using MLCC technology are solid and generally rectangular, the performance to size ratio is maximized.

Conductive Pattern

According to one or more embodiments of the present invention, the device 10 features certain layers 11 comprised non-conductive material such as ceramic or ferroceramic or similar materials or combinations thereof, that are to be combined into a magnetic component and have a conductive material 12, such as palladium deposited on the layers 11 which creates defined pattern 14 of conductive material on the layer surface 16. This pattern 14 when printed, screened, or otherwise deposited, on the layer surface 16 of a plurality of multiple successive layers 11 and caused to come into operative electrical contact with one another, creates a series of turns of the conductive material, which replaces wire wound the coils 100 and 110 used in conventional magnetic components. The pattern 14 would be deposited to yield minimal thickness to avoid air gaps between the layers 11. Currently a thickness in a range from 3 to 30 microns is preferred however that might vary depending on application. The best form of the pattern 14 as herein disclosed forms windings or turns at the rate of one full turn per layer 11.

Inductance

Varying the number of turns on each layer of nonconductive material has the practical effect of changing the functional parameters related to the magnetic component (i.e., each layer may represent a full turn or a smaller unit depending on the location of the starting and ending points). For instance, inductance may be varied in a transformer. The formula for calculating inductance is:

L=4p*N²*CC* where:

L=inductance in nano-Henries;

N=the number of turns in the coil;

CC=the core constant in cm=magnetic cross-sectional area/magnetic path length; and

=the initial permeability of the non-conductive material.

Referring to FIG. 2, the magnetic cross-sectional areas 17 are the areas 17 within the printed conductor patterns 14.

Referring to the above formula for inductance, it can be seen that inductance increases as a squared function of the turns and decreased as a linear function of the core constant. Therefore, increasing the effect of the turns has a larger impact on inductance than the decreasing effect of the core constant. The practical effects of having a large number of turns in a small number of layers 11 are to reduce the time and the cost involved in manufacturing the magnetic components with specific amounts of inductance using MLCC technology or to greatly increase the amount of inductance possible in a magnetic component having a specified height.

In one embodiment of the device 10, as depicted in FIG. 2 the pattern 14 is essentially shaped as a square, except having a starting point 18 and an ending point 20 that are slightly offset. The disclosed embodiment features terminating layers 13 at the top and bottom of the stack of layers 11 which each have a slightly different pattern 14 deposited on the layer surface 16 to accommodate a starting point 18 that can be used to communicate with the component to which the device 10 will be affixed. Of course this starting point 18 on both terminating layers could be deposited on the layer surface 16 in an infinite number of shapes or configurations to accommodate the desired electrical attachment at the starting point 18 and the intended attached electrical component such as a circuit board or conventional chip carrier. Also depicted in FIG. 2 are the top and bottom end layers 26 which provide an insulating layer if desired between the terminating layers 13 with formed pattern 14 and the exterior of the device 10.

In this depiction of an embodiment of the device 10 the non-conductive layer 11 has a pattern 14 deposited on a surface 16 where the pattern is made of an electrically conductive material. Starting point 18 may be traced in a counter clockwise direction, or clockwise, where it will end at ending point 20. As depicted, in the current best mode of the device 10 the starting point 18 is located immediately adjacent to the ending point 20 by placing a notch 23 in patter 14 at both the starting point 18 and the ending point 20 in a manner to allow an overlap 21 of the pattern 14.

By following the so deposited pattern 14 from the starting point 18 to the ending point 20, a 360 degree rotation may be achieved on each layer 11. As shown in the internal layers 11 the starting point 18 and ending point 20 are both on a centerline bisecting the layer 11 and are positioned close together but are slightly offset so that they do not contact one another, thereby creating essentially one wind per layer 11 around a center axis 15 of the device 10.

To simulate a conductive coil used in a traditional magnetic coil, the adjacent layers 11 have substantially the same shape of the pattern 14 except that the pattern 14 has been flipped around center-line at center axis 15. Therefore, with reference to FIG. 2, the starting point 18 of the pattern 14 on one layer 11 is offset and lines up with an ending point 20 of an adjacent layer 11 thereby completing two windings, one on each layer 11.

Layers 11 and the patterns 14 deposited thereon, are then electrically connected to one another thereby forming the continuous looping or winding of a conventional transformer or similar magnetic component.

In the preferred embodiments this electrical communication between layers 11, starting points 18 and ending points 20 is provided by producing small apertures communicating through the layer 11 called vias 22 at the starting point 18 and ending points 20 of each pattern 14 forming the loop on each layer 11. Filling the vias 22 with conductive material generally the same as the material deposited to form the pattern 14 creates an electrical contact at the ending points 20 of one layer 11 with the starting points 18 of adjacent layers 11. Alternating the pattern 14 for the entire plurality of layers 11 with patterns 14 which alternate the notches 23 at the respective starting points 18 and ending points 20 allows for communication between the single winding formed on each layer 11 thereby making up the component intended. An infinite number of combinations of additional layers 11 may be used in this example where each layer corresponds to a full turn in a conventional wire-wound coil. The overlap 21 formed by the alternating notches 23 serves to allow for easy connection to the next layer 11 as well as improving the field formed by the windings by totally enclosing the ends of each winding formed on each layer. As is obvious to those skilled in the art, in other embodiments, the locations of the starting and ending points may be varied to simulate smaller degreed turns in the traditional wire-wound coil or to accommodate the mating structure for mounting of the device 10 and such is anticipated.

Primary and Secondary Coils

In one preferred embodiment yielding a transformer, as best depicted in FIG. 6, the turns of a first or primary coil 28 are produced by stacking the layers 11 having the conductive ink forming the pattern 14 on one surface 16 and connecting them electrically using ink or other conductive material through the vias 22 until a coil of the desired number of turns is formed. Next, one or more layers of non-conductive material are stacked upon the coil so formed as a separation layer 32. Then, the layering process repeats where a second or secondary coil 30 is produced in the same fashion using the desired number of layers 11, each having one turn per layer formed by the pattern 14 of conductive ink or material and therein connected electrically using the vias 22.

Of course the ratio of windings of the primary coil 28 to the secondary coil 30 would be calculated to yield the voltage increase or drop desired and the number of layers 11 each with a winding, forming the two respective coils would be adjusted to yield the desired ratio of the two coils formed.

Transformers frequently provide variable voltage output through the provision of a center tap layer 41 which allows tapping the voltage produced by the intended coil at a point to yield the desired voltage level output which may be more or less than that of the top or bottom connection points 36. Here, the center tap layer 41 is provided by a center tap layer 41 having a center tap external connection 36. The pattern 14 would be formed on the center tap layer 41 to accommodate the external connection 36 and also communicate with adjacent layers 11 using the aforementioned vias.

On the exterior of the layers 11 having the conductive ink or similar material deposited thereon to form the pattern 14 forming the full winding, which when electrically connected forms the multiple coils, one or more additional nonconductive end layers 26 may be added. This completes and encloses the device in an outside insulated shell of the magnetic component forming a transformer having a primary coil 28 and secondary coils 30.

Finally, the layers 11 so formed and connected to each other to a transformer, are secured to each other to maintain their relative positions. In the current best mode of the device, the entire configuration of a stacked plurality of layers 11 and end layers 26 is heated, or fired in a kiln, causing the layers 11 to bond to each other and to form a unitary structure that is the desired magnetic component and is compact and may be much smaller than can be produced using conventional wire wound coils. This enhances the ability to use the produced magnetic components in applications where a smaller size is advantageous.

FIG. 4 depicts the device of FIG. 2 with the addition of end layers 26 and thereafter heated to form the unitary structure of layers 11 each with a full winding thereon. FIG. 4 shows the connection points 36 communicating to the exterior of the device for attachment to the intended component. Of course those skilled in the art may make modifications to the position and shape of the connection points 36 to fit the intended mounting and component and such are anticipated.

Another magnetic component formed using MLCC technology as herein described is featured in FIG. 5 which is a side cut away of a solenoid. This embodiment shows the plunger 40 axially located in the magnetic cross-sectional area 17 formed by the plurality of stacked layers 11 each with a full turn or loop formed by the pattern 14 on the surface 16. This side view also depicts another preferred mode of outside connection to the intended mounting using vias 22 communicating on each layer 11 with external connection points 36 thereby forming a line 42 of such connection points 36 on the formed component. Of course this line 42 style of external connection points 36 could be used on any of the components herein disclosed or components formed using the MLCC technology and such is anticipated.

Thus, magnetic components produced using MLCC technology are described in conjunction with one or more specific embodiments. The invention is defined by the claims and their full scope of equivalents. While all of the fundamental characteristics and features of magnetic components produced using MLCC technology and method herein disclosed have been shown and described, it should be understood that various substitutions, modifications, and variations may be made by those skilled in the art without departing from the spirit or scope of the invention. Consequently, all such modifications and variations are included within the scope of the invention.

What is claimed is:

1. A method for producing a magnetic component comprising:
producing a plurality of layers of non-conductive material;
applying a conductive pattern to at least a first and a second layer of said non conductive material;
said conductive pattern substantially forming one loop on each of said layers, said loop having a starting point and ending point;
causing said ending point of said conductive pattern to come into electrical contact with said starting point of said conducting pattern on at least said first and said second layers respectively; and
combining said layers of said non-conductive material.

2. The method of claim 1 wherein said combining of said layers of said non-conductive material is accomplished by heating said layers, thereby causing said layers to form a unitary structure.

3. The method of claim 1 wherein said layers are comprised of a material from a group of materials including ceramic and ferroceramic.

4. The method of claim 1 wherein said conductive pattern is made of palladium, or other conductive material.

5. The method of claim 1 wherein said conductive pattern is substantially a square.

6. The method of claim 1 further comprising:
producing one or more additional layers of non-conductive material;
applying said conductive pattern to at least a first and second layer of said additional layers of said non-conductive material;
causing said ending point of said conductive pattern on said first additional layer to come into electrical contact with said starting point of said conductive pattern on at least said second additional layer;
inserting one or more center non-conductive layers between said layers and said additional layers; and
combining said additional layers, said layers, and said center layers of said non-conductive material.

7. The method of claim 6 wherein said combining of said additional layers, said layers, and said center layers of said non-conductive material is accomplished by heating said layers, thereby causing said layers to form a unitary structure.

8. The method of claim 2 wherein said magnetic component is an inductor.

9. The method of claim 6 wherein said magnetic component is a transformer

10. A magnetic component comprising:
a plurality of layers of non-conductive material;
a conductive pattern applied to at least a first and second layer of said plurality of layers of non-conductive material;
said conductive pattern forming substantially a complete loop, said loop having a starting point and an ending point; and
a connection causing said ending point of said conductive pattern on at least said first layer to come into electrical contact with said begging point of said conductive pattern on said second layer, and
means of attachment of said plurality of layers of nonconductive material to each other to form a unitary structure.

11. The magnetic component of claim 10 wherein each additional layer of non-conductive material having said conductive pattern applied thereon is connected to an adjacent layer of non-conductive material having said conductive pattern applied thereon by respective endpoint of said conductive pattern electrically communicating with beginning point on the adjacent layer of non-conductive material.

12. The magnetic component of claim 10 wherein said magnetic component is one of a group of magnetic components consisting of a relay, solenoid, and a motor.

13. The magnetic component of claim 10 wherein said layers are made of ceramic or Ferro ceramic.

14. The magnetic component of claim 10 wherein said conductive pattern is made of palladium or other conductive material.

15. The magnetic component of claim 10 wherein said conductive pattern is substantially a square.

16. The magnetic component of claim 10 further comprising:
one or more additional layers of non-conductive material;
a second conductive pattern applied to at least a first and second layer of said additional layers of said nonconductive material;
said second conductive pattern having a begriming point and an end point;
a connection causing end point of said second conductive pattern on said first layer to come into electrical contact with said beginning point of said second conductive pattern on second layers; and
one or more center non-conductive layers inserted between said layers and said additional layers;
means of attachment of said additional layers, said layers, and said center layers of said non-conductive material to form a unitary structure.

17. The magnetic component of claim 16 wherein said magnetic component is one of a group of magnetic components including a transformer, an inductor, a relay, a solenoid, and a motor.

18. A magnetic component comprising:
a top layer of non conductive material having a conductive pattern applied to a surface, said conductive pattern having a starting point and termination point;
a bottom layer of non-conductive material having a conductive pattern applied to a surface, said conductive pattern having a begriming point and a termination point;
a plurality of adjacent internal layers of non-conductive material each having a conductive pattern applied to a surface of said layer of non-conductive material;
each of said conductive pattern forming substantially a complete loop, said loop having a starting point and an ending point;
a notch formed in each of said conductive pattern at said starting point,
a second notch formed in each of said conductive pattern point and at said ending point;
said notch in each of said conductive pattern at starting point sized to accommodate the area of each of said conductive pattern at said ending point adjacent to said second notch;
said notch in each of said conductive pattern at ending point sized to accommodate the area of each of said conductive pattern at said starting point adjacent to said first notch;
said first notch and said second notch sized to prevent electrical contact between said starting point and said ending point;
a connection communicating electrical contact between said ending point of said conductive pattern each said plurality of internal layers on non-conductive material with said begging point of said conductive pattern formed on any adjacent layer of said plurality of internal layers of nonconductive material;
said beginning point of said conductive pattern on the first of said plurality of adjacent internal layers electrically communicating with said starting point of said conductive pattern applied to the surface of said top layer;
said ending point of said conductive pattern of the last of said plurality of adjacent internal layers electrically communicating with said beginning point of said conductive pattern of said bottom layer; and
means of attachment of said plurality of adjacent layers of non-conductive material and said top layer and said bottom layer, to each other to forming a unitary structure, with said plurality of adjacent internal layers sandwiched between said top layer and said bottom layer and said termination point of said top layer electrically communicates with said termination point of said bottom layer.

19. The magnetic component of claim 18 additionally comprising:
a separation layer of non-conducting material attached to said unitary structure;
a second coil component, said second coil component comprising:
a top layer of non conductive material having a conductive pattern applied to a surface, said conductive pattern having a starting point and termination point;
a bottom layer of non-conductive material having a conductive pattern applied to a surface, said conductive pattern having a begriming point and a termination point;
a plurality of adjacent internal layers of non-conductive material each having a conductive pattern applied to a surface of said layer of non-conductive material;
each of said conductive pattern forming substantially a complete loop, said loop having a starting point and an ending point;
a notch formed in each of said conductive pattern at said starting point,
a second notch formed in each of said conductive pattern point and at said ending point;
said notch in each of said conductive pattern at starting point sized to accommodate the area of each of said conductive pattern at said ending point adjacent to said second notch;
said notch in each of said conductive pattern at ending point sized to accommodate the area of each of said conductive pattern at said starting point adjacent to said first notch;
said first notch and said second notch sized to prevent electrical contact between said starting point and said ending point;
a connection communicating electrical contact between said ending point of said conductive pattern each said plurality of internal layers on non-conductive material with said begging point of said conductive pattern formed on any adjacent layer of said plurality of internal layers of nonconductive material;
said beginning point of said conductive pattern on the first of said plurality of adjacent internal layers electrically communicating with said starting point of said conductive pattern applied to the surface of said top layer;
said ending point of said conductive pattern of the last of said plurality of adjacent internal layers electrically communicating with said beginning point of said conductive pattern of said bottom layer;
means of attachment of said second coil component formed by plurality of adjacent layers of non-conductive material and said top layer and said bottom layer, to each other to form a second unitary coil structure; and
means of attachment of said second unitary coil structure to said separation layer thereby forming a transformer of unitary construction.
